(19) United States
(12) Patent Application Publication
(10) Pub. No.: US 2015/0109096 A1
(43) Pub. Date: Apr. 23, 2015

(54) HANDHELD ELECTRONIC DEVICE AND OPERATION METHOD OF THE SAME

(71) Applicant: HTC Corporation, Taoyuan County (TW)

(72) Inventors: Wei-Chien WANG, Taoyuan County (TW); Chih-Wei HSU, Taoyuan County (TW); Cheng-Hsi LIU, Taoyuan County (TW)

(73) Assignee: HTC Corporation, Taoyuan County (TW)

(21) Appl. No.: 14/060,630

(22) Filed: Oct. 23, 2013

(51) Int. Cl. G08C 19/28; G08C 17/02

(52) U.S. Cl. CPC G08C 19/28; G08C 17/02; G08C 2201/92
USPC 340/5.1; 340/12.5

(57) ABSTRACT

A handheld electronic device is provided. The handheld electronic device comprises a storage unit, an audio sensor, a processing unit and a wireless control unit. The storage unit is configured to store first device data and first control data. The audio sensor is configured to receive an audio and generates an audio signal accordingly. The processing module identifies electronic device information according to the audio input and searches the storage module to retrieve a corresponding device code set from the device code sets. The infrared control module generates an infrared control signal to an electronic device to be controlled according to the corresponding device code set and an input control signal from the processing module after the corresponding device code set is retrieved to control the electronic device.

### BACKGROUND

1. Field of Invention

The present application relates to electronic device operation technology. More particularly, the present application relates to a handheld electronic device and an operation method of the same.

2. Description of Related Art

In order to increase the convenience for life or meet the entertainment demand in a family, various household appliances are usually purchased. Many appliances, such as a television, a video recorder, a stereo system and an air conditioner, are all configured with an independent remote controller correspondingly. When there are more and more appliances presented, the number of remote controllers is increased accordingly. Therefore, the user may be confused by different remote controllers, may lose the remote controllers or may damage the remote controllers. The large number of the remote controllers cause inconvenience for using household appliances.

When the remote controller is lost or damaged, users often purchase a universal remote controller to replace the original remote controller. In order to enable the universal remote controller to operate the appliances, device codes of different brands, types and models of the appliances should be provided in the universal remote controller, and a complicated test procedure is performed to find a correct device code for operation. However, the general remote controller in the market has no intuitive display mechanism to inform users of how the procedure is performed. Users not only need to try every device code but also need to pay attention to keep in mind that which function key is selected for testing at any time. Besides the concentration that the user needs, the test procedure with low efficiency also makes the whole procedure quite time-consuming and strenuous.

Therefore, what is needed is to design a handheld electronic device to quickly search for the corresponding device code by using the data processing ability thereof to control home appliances or other electronic devices.

### SUMMARY

An object of the present application is to provide a handheld electronic device for controlling an external wireless device. The handheld electronic device includes a storage unit, an audio sensor, a processing unit, and a wireless control unit. The storage unit is configured to store first device data and first control data corresponding to the first device data. The audio sensor is configured to receive an audio and generates an audio signal according to the audio. The processing unit is coupled to the storage unit and the audio sensor and is configured to identify audio information according to the audio signal. The wireless control unit is coupled to the processing unit and is configured to generate a wireless signal to control the external wireless device. When the processing unit determines that the audio information matches the first device data, the wireless control unit generates the wireless signal according to the first control data.

Another object of the present application is to provide a method for controlling an external wireless device through a handheld electronic device. The method includes the steps outlined below. First device data and first control data corresponding to the first device data are stored. An audio is received. An audio signal is generated according to the audio. Audio information is identified according to the audio signal. A wireless signal is generated according to the first control data when the audio information is determined to be matched with the first device data to control the external wireless device.

These and other features, aspects, and advantages of the present application will become better understood with reference to the following description and appended claims.

It is to be understood that both the foregoing general description and the following detailed description are by examples, and are intended to provide further explanation of the application as claimed.

### BRIEF DESCRIPTION OF THE DRAWINGS

The application can be more fully understood by reading the following detailed description of the embodiment, with reference made to the accompanying drawings as follows:

FIG. 1 is a block diagram of a handheld electronic device in an embodiment of the present application;

FIG. 2 is an exemplary diagram of the control data in FIG. 1 in an embodiment of the present application;

FIG. 3 is a top view of the handheld electronic device in an embodiment of the present application;

FIG. 4 is a block diagram of a handheld electronic device in another embodiment of the present application;

FIG. 5 is a block diagram of a handheld electronic device in yet another embodiment of the present application; and

FIG. 6 is a flow chart of a method in an embodiment of the present application.

### DETAILED DESCRIPTION

Reference will now be made in detail to the present embodiments of the application, examples of which are illustrated in the accompanying drawings. Wherever possible, the same reference numbers are used in the drawings and the description to refer to the same or like parts.

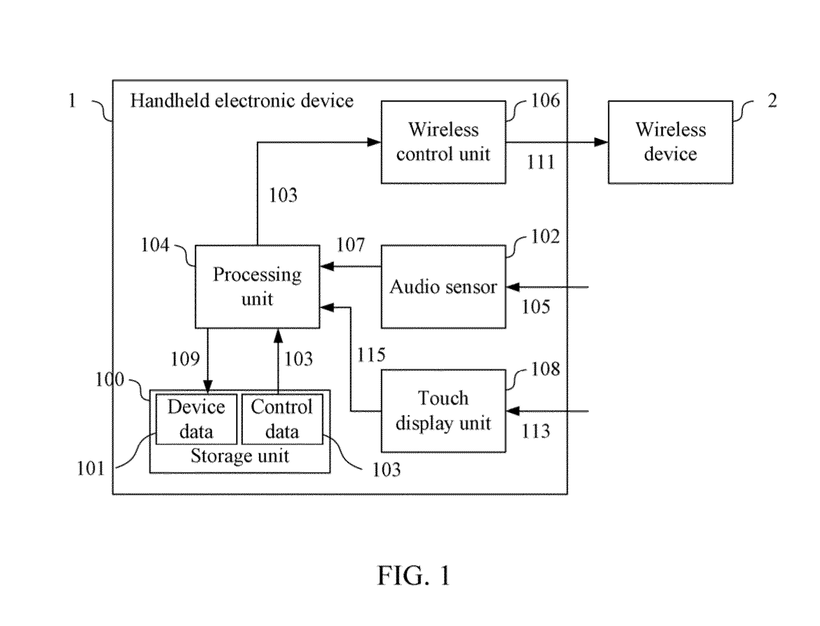

FIG. 1 is a block diagram of a handheld electronic device 1 in an embodiment of the present application. The handheld electronic device includes a storage unit 100, an audio sensor 102, a processing unit 104, a wireless control unit 106 and a touch display unit 108.

The storage unit 100 is configured to store device data 101 and control data 103. In different embodiments, the device data 101 includes information related to different electronic devices such as, but not limited to the information of models, trademarks, patterns, manufacturers or a combination of the above of the electronic devices. Further, the information is either in the form of such as, but not limited to text, image or pattern. The control data 103 includes control information corresponding to different electronic devices such as, but not limited to the information of codes to control different electronic devices to perform different functions.

The audio sensor 102 is configured to receive an audio 105. In an embodiment, the audio sensor 102 can be a microphone. The audio sensor 102 generates an audio signal 107 according to the received audio 105. The processing unit 104 is coupled to the storage unit 100 and the audio sensor 102. The processing unit 104 is configured to identify audio information 109 according to the audio signal 107. Moreover, the processing unit 104 is configured to perform search in the device data 101 in the storage unit 100 according to the audio information 109 and make comparison between the audio information 109 and the device data 101.

The wireless control unit 106 is coupled to the processing unit 104. In an embodiment, when the processing unit 104 determines that the audio information 109 matches one piece of the device data 101, the processing unit 104 retrieves the control data 103 corresponding to the matched device data 101 such that the wireless control unit 106 generates a wireless signal 111 according to the control data 103.

In different embodiments, the wireless control unit 106 can be an infrared unit, a Bluetooth unit or a wireless fidelity (Wi-Fi) unit to generate the wireless signal 111 in the form of an infrared signal or the wireless signal 111 that matches the wireless communication protocols of Bluetooth and Wi-Fi. The wireless signal 111 is transmitted to a wireless device 2 by using the wireless communication technology to control the wireless device 2.

The wireless device 2 can be an electronic device that is able to receive the wireless signal 111 and is able to be controlled by the wireless signal 111. In different embodiments, the wireless device 2 can be such as, but not limited to a television, an air conditioner, a stereo player or a DVD player. The wireless device 2 can be controlled to perform different functions such as, but not limited to power-on, power off or other specific functions. For example, if the wireless device 2 is a television, the wireless signal 111 generated by the wireless control unit 106 can control the television to adjust the volume, switch the channel or change the display mode.

For example, when the user speaks “Sony KDL-55HX750” to the handheld electronic device 1, the audio sensor 102 receives the audio 105 and generates the audio signal 107. The processing unit 104 identifies the audio information 109 in the audio signal 107 and performs search in the device data 101 in the storage unit 100 according to the audio information 109. When a piece of the device data 101 includes the information corresponding to the manufacturer of Sony and the model of KDL-55HX750, the processing unit 104 determines that the audio information 109 matches the device data 101 and retrieves the corresponding control data 103. The wireless control unit 106 generates the wireless signal 111 according to the control data 103 to control the television that the manufacturer and the model thereof match the information of “Sony KDL-55HX750”.

It is noted that the manufacturer and the device in the embodiment described above is merely an example. In other embodiments, the electronic device 2 can be of other brands, models of types, such as but not limited to a DVD player of Samsung or an air conditioner of Toshiba.

The detail of various embodiments of the handheld electronic device 1 is disclosed in the subsequent paragraphs.

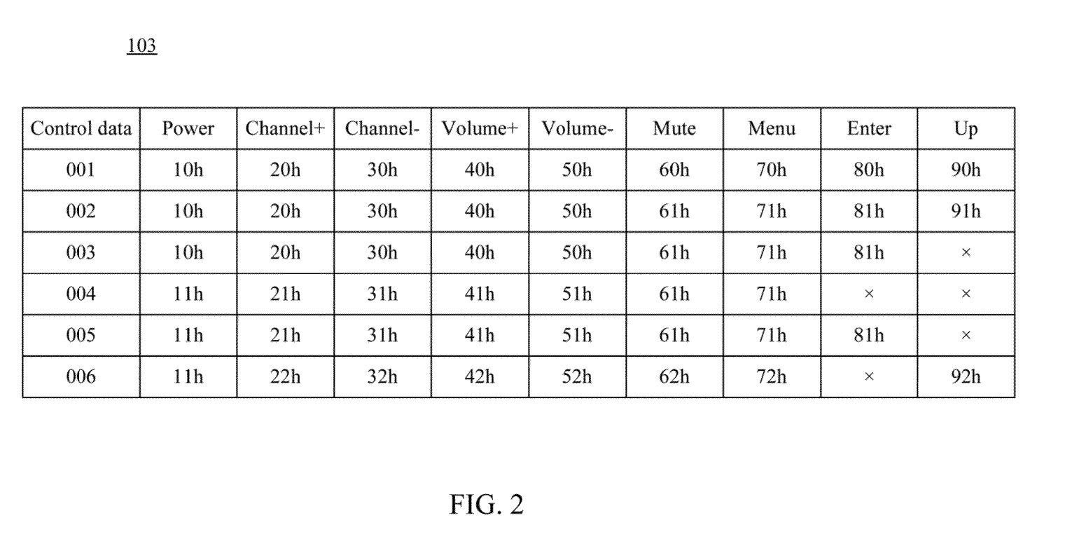

FIG. 2 is an exemplary diagram of the control data 103 in FIG. 1 in an embodiment of the present application. In the present embodiment, each row of codes corresponds to a piece of the control data 103. The control data 103 may include such as but not limited to the identification code in the first entry and a plurality of functional control codes in the other entries. Each of the functional control codes corresponds to a function of the wireless device 2. Take the control data 103 having the identification code 001 as an example, the device control codes 10h, 20h and 30h included therein are used to turn on the wireless device 2, increase the channel and decrease the channel, respectively.

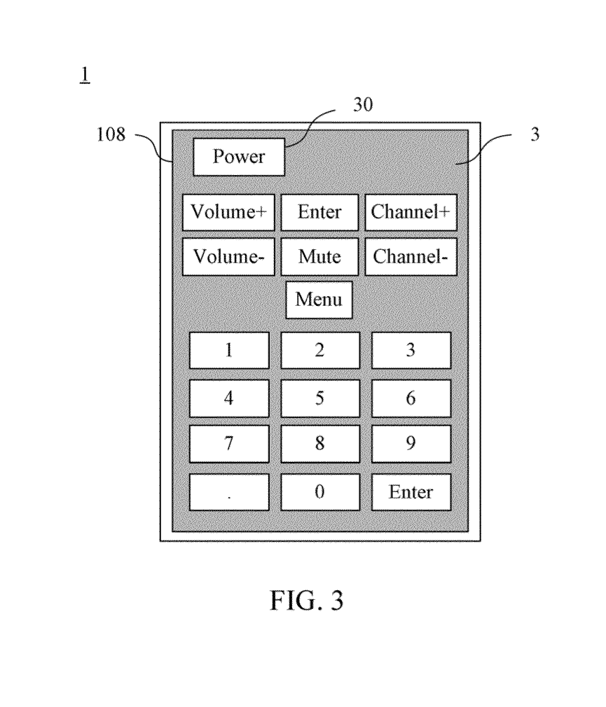

Referring to FIG. 1 and FIG. 3 at the same time. FIG. 3 is a top view of the handheld electronic device 1 in an embodiment of the present application. In the present embodiment, the processing unit 104 not only retrieves the control data 103 after the audio information 109 is determined to be matched with the device data 101, but also controls the touch display unit 108 to display a corresponding user interface 3. The user interface 3 may include a plurality of virtual keys 30 corresponding to different functions of the wireless device 2.

The touch display unit 108 further receives a selection input 113 corresponding to the user interface 20 to select one of the functions and generates an input signal 115. In an embodiment, the processing unit 104 searches for a segment of the functional control code described above corresponding to the function from the control data 103 according to the input signal 115. The wireless control unit 106 generates the wireless signal 111 according to the control data 103 and the input signal 115 to control the wireless device 2 to perform the function.

For example, when the user touches the virtual key 30 labeled as “power”, the wireless control unit 106 generates the wireless signal 111 according to the functional control code corresponding to the power switching in the control data 103 to either turn on or turn off the wireless device 2.

It is noted that in the present embodiment, the display of the user interface 3 and the reception of the selection input 113 are accomplished by using a single touch display device 108 of the handheld electronic device 1. In other embodiments, the display of the user interface 3 and the reception of the selection input 113 can be accomplished by using a display unit (not shown) and an input unit (not shown) that are independent to each other. The present application is not limited thereto.

Accordingly, the handheld electronic device 1 can identify the audio information in the audio signal that is generated according to an audio received by the audio sensor. Moreover, the matched device data is determined according to the audio information such that the wireless control unit generates the wireless signal according to the control data corresponding to the device data to control the wireless device.

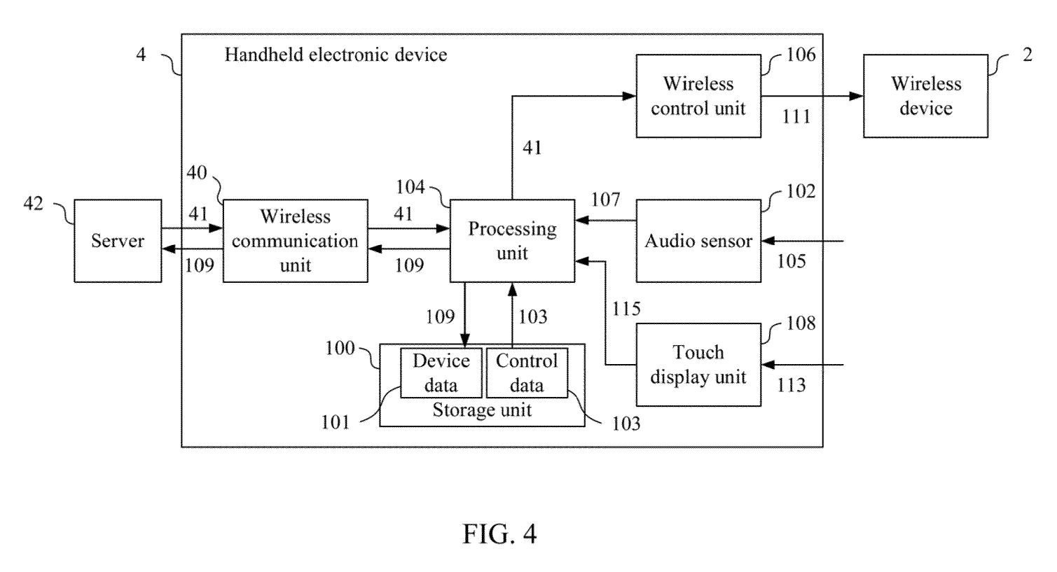

FIG. 4 is a block diagram of a handheld electronic device 4 in another embodiment of the present application. The components included in the handheld electronic device 4 illustrated in FIG. 4 are similar to those in the handheld electronic device 1 illustrated in FIG. 1. Accordingly, the identical components are not described in detail herein. In the present embodiment, the handheld electronic device 4 further includes a wireless communication unit 40.

When the processing unit 104 determines that the audio information 109 does not match the device data 101, the processing unit 104 wirelessly connects to a server 42 through the wireless communication unit 40. The wireless communication unit 40 is configured to perform wireless communication with the server 42. Therefore, the processing unit 104 can transmit the audio information 109 to the server 42 through the wireless communication unit 40. After the server 42 performs search in the database (not shown) therein, the processing unit 104 further receives the control data 41 from the server 42 through the wireless communication unit 40. The wireless control unit 106 generates the wireless signal 111 according to the control data 41.

In different embodiments, the wireless communication unit 40 can include an infrared unit, a Bluetooth unit, a Wi-Fi unit, an optical unit or a sound-producing unit.

Consequently, in the present embodiment, when the data in the handheld electronic device 4 does not include the device control code corresponding to the wireless device 2, the handheld electronic device 4 is wirelessly connected to the server of such as, but not limited to the manufacturer of the wireless device 2, the manufacturer of the handheld electronic device 4 or the server having the related information. The related control data 41 is retrieved to control the wireless device 2.

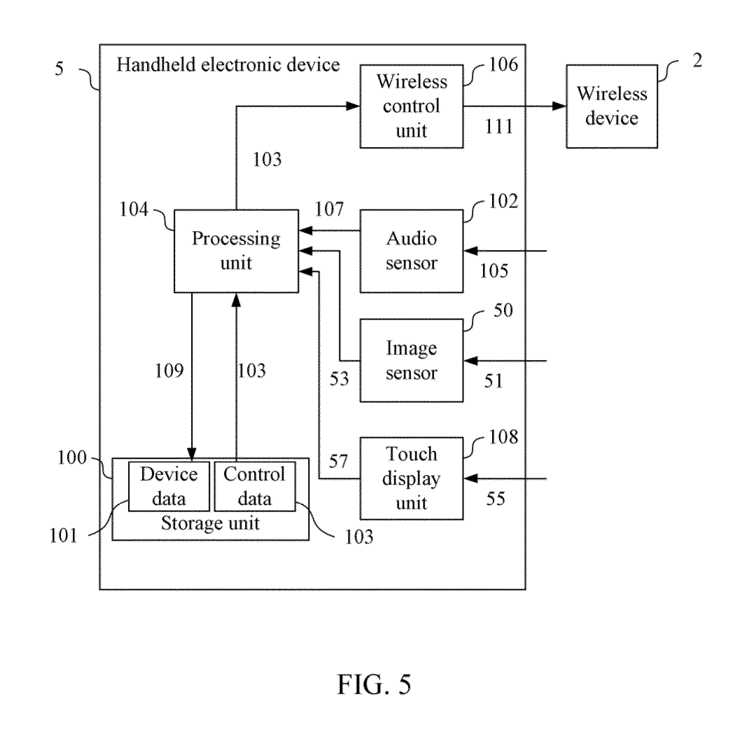

FIG. 5 is a block diagram of a handheld electronic device 5 in yet another embodiment of the present application. The components included in the handheld electronic device 5 illustrated in FIG. 5 are similar to those in the handheld electronic device 1 illustrated in FIG. 1. Accordingly, the identical components are not described in detail herein. In the present embodiment, the handheld electronic device 5 further includes an image sensor 50.

The image sensor 50 is coupled to the processing unit 104. When the processing unit 104 determines that the audio information 109 does not match the device data 101, the image sensor 50 retrieves an image 51 related to the wireless device 2 such that the processing unit 104 generates image information 53 according to the retrieved image 51.

The image information 53 may include a pattern of a model (e.g. the mark or the sticker on the case having the information of the model), a trademark, a physical appearance or a barcode of the wireless device 2. The processing unit 104 performs image identification and image processing on the image information 53. The image identification and the image processing include processes such as edge detection, segmentation and image matching to retrieve the information related to the wireless device 2. The processing unit 104 further determines whether the image information 53 matches the device data 101. When the image information 53 matches one piece of the device data 101, the wireless control unit 106 generates the wireless signal 111 according to the control data 103 corresponding to the device data 101.

In yet another embodiment of the present application, if the processing unit 104 determines that both of the audio information 109 and the image information 53 do not match the device data 101, an input 55 is received from the touch display unit 108 to generate the input data 57.

In an embodiment, the input data 57 is a text input. The user can directly input the manufacturer and the model of the wireless device 2 such that the processing unit 104 determines whether the input data 57 matches the device data 101. When the input information 57 matches one piece of the device data 101, the wireless control unit 106 generates the wireless signal 111 according to the control data 103 corresponding to the device data 101.

Consequently, the handheld electronic device can receive information of image, text or other types by using other input devices such as an image sensor or an input unit. The device data is determined to be matched with the information such that the wireless control unit generates the wireless signal according to the control data corresponding to the device data to control the wireless device.

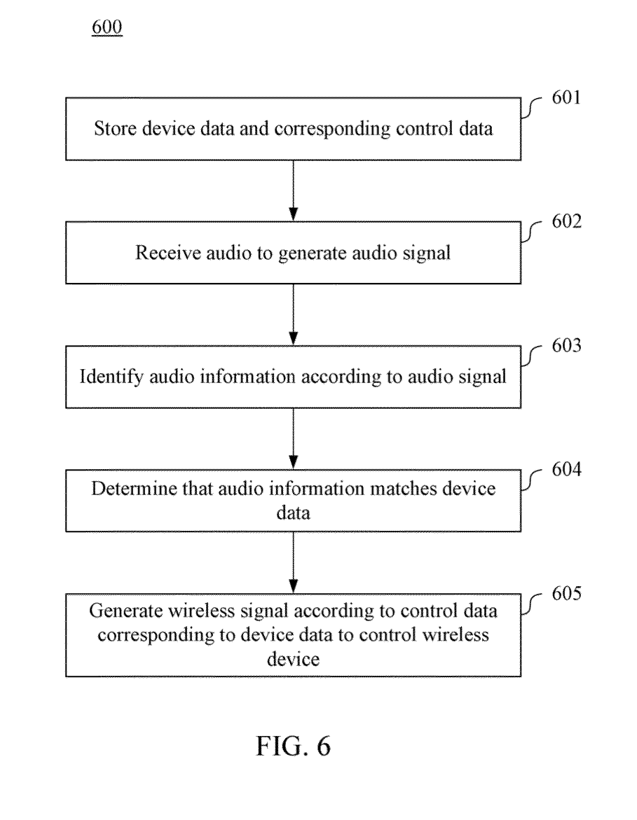

FIG. 6 is a flow chart of a method 600 in an embodiment of the present application. The method 600 can be used in the handheld electronic devices 1, 4 and 5 illustrated in FIG. 1, FIG. 4 and FIG. 5. The handheld electronic device 1 is used as the example in the present embodiment. The method 600 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 601, the device data 101 and the control data 103 corresponding to the device data 101 are stored in the storage unit 100.

In step 602, the audio 105 is received by the audio sensor 104 to generate the audio signal 107.

In step 603, the audio information 109 is identified according to the audio signal 107 by the processing unit 104.

In step 604, the audio information 109 is determined to be matched with the device data 101 by the processing unit 104. The wireless signal 111 is generated according to the control data 103 corresponding to the device data 101 by the wireless control unit 106 to control the wireless device 2.

Although the present application has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims

What is claimed is:

1. A handheld electronic device for controlling an external wireless device, wherein the handheld electronic device comprises:
a storage unit configured to store first device data and first control data corresponding to the first device data;
an audio sensor configured to receive an audio and generates an audio signal according to the audio;
a processing unit coupled to the storage unit and the audio sensor and configured to identify audio information according to the audio signal; and
a wireless control unit coupled to the processing unit and configured to generate a wireless signal to control the external wireless device;
wherein when the processing unit determines that the audio information matches the first device data, the wireless control unit generates the wireless signal according to the first control data.

2. The handheld electronic device of claim 1, wherein the storage unit is further configured to store second device data and second control data corresponding to the second device data, wherein when the processing unit determines that the audio information matches the second device data, the wireless control unit generates the wireless signal according to the second control data.

3. The handheld electronic device of claim 1, further comprising an image sensor coupled to the processing unit, wherein when the processing unit determines that the audio information does not match the first device data, the image sensor retrieves an image related to the external wireless device such that the processing unit generates an image information according to the retrieved image, and when the processing unit determines that the image information matches the first device data, the wireless control unit generates the wireless signal according to the first control data.

4. The handheld electronic device of claim 3, wherein the image related to the external wireless device comprises a pattern of a model, a trademark, a physical appearance or a barcode of the external wireless device.

5. The handheld electronic device of claim 1, further comprising an input unit coupled to the processing unit, wherein when the processing unit determines that the image information does not match the first device data, the input unit receives an input such that the processing unit generates an input information according to the input, and when the processing unit determines that the input information matches the first device data, the wireless control unit generates the wireless signal according to the first control data.

6. The handheld electronic device of claim 1, further comprising an input unit coupled to the processing unit, wherein when the processing unit determines that the audio information does not match the first device data, the input unit receives an input such that the processing unit generates an input information according to the input, and when the processing unit determines that the input information matches the first device data, the wireless control unit generates the wireless signal according to the first control data.

7. The handheld electronic device of claim 1, further comprising a wireless communication unit coupled to the processing unit, wherein when the processing unit determines that the audio information does not match the first device data, the processing unit wirelessly connects to a server through the wireless communication unit and the wireless communication unit is configured to transmit the audio information from the processing unit to the server, such that the processing unit receives a third control data from the server through the wireless communication unit and the wireless control unit generates the wireless signal according to the third control data.

8. The handheld electronic device of claim 1, wherein the wireless communication unit comprises one of an infrared unit, a Bluetooth unit, a wireless fidelity (Wi-Fi) unit, an optical unit and a sound-producing unit.

9. The handheld electronic device of claim 1, further comprising:
a display unit to display a corresponding user interface when the processing unit determines that the audio information matches the first device data; and
an input unit to receive a selection input corresponding to the user interface and generate an input signal, and the wireless control unit generates the wireless signal according to the first control data and the input signal.

10. The handheld electronic device of claim 9, wherein the display unit and the input unit are integrated into a touch display unit and the user interface comprises a plurality of virtual keys.

11. A method for a handheld electronic device controlling an external wireless device, wherein the method comprises:
storing first device data and first control data corresponding to the first device data;
receiving an audio;
generating an audio signal according to the audio;
identifying audio information according to the audio signal; and
generating a wireless signal according to the first control data when the audio information is determined to be matched with the first device data to control the external wireless device.

12. The method of claim 11, further comprising:
determining that the audio information does not match the first device data;
retrieving an image related to the wireless device;
generating an image information according to the retrieved image; and
generating the wireless signal according to the first control data when the image information is determined to be matched with the first device data.

13. The method of claim 12, further comprising:
determining that the image information does not match the first device data;
receiving an input;
generating an input information according to the input; and
generating the wireless signal according to the first control data when the input information is determined to be matched with the first device data.

14. The method of claim 11, further comprising:
determining that the audio information does not match the first device data;
receiving an input;
generating an input information according to the input; and
generating the wireless signal according to the first control data when the input information is determined to be matched with the first device data.

15. The method of claim 11, further comprising:
determining that the audio information does not match the first device data;
connecting wirelessly to a server to transmit the audio information to the server;
receiving a third control data from the server; and
generating the wireless signal according to the third control data.

16. The method of claim 11, further comprising:
displaying a corresponding user interface when the audio information is determined to be matched with the first device data; and
receiving a selection input corresponding to the user interlace, generating an input signal, and generating the wireless signal according to the first control data and the input signal.
